(19) United States
(12) Patent Application Publication
(10) Pub. No.: US 2026/0352930 A1
(43) Pub. Date: Nov. 5, 2026

(54) METHOD, APPARATUS, DEVICE, READABLE STORAGE MEDIUM AND PRODUCT FOR RENDERING LIVE STREAMING EFFECT

(71) Applicant: Beijing Zitiao Network Technology Co., Ltd., Haidian District, Beijing (CN)

(72) Inventors: Yi Zhang, Beijing (CN); Jiawei Li, Beijing (CN); Siying Chen, Beijing (CN)

(21) Appl. No.: 19/139,033

(22) PCT Filed: Dec. 1, 2023
(86) PCT No.: PCT/CN2023/135967

§ 371 Date: Jun. 13, 2025

(30) Foreign Application Priority Data
Dec. 15, 2022 (CN) 202211612984.X

(51) Int. Cl. H04N 21/81; G06T 3/40; G06T 11/60; G06V 10/60; H04N 21/2187; H04N 21/234

(52) U.S. Cl. CPC H04N 21/8153; G06T 3/40; G06T 11/60; G06V 10/60; H04N 21/2187; H04N 21/23412; H04N 21/23418

(57) ABSTRACT

The embodiment of the disclosure provides a method, an apparatus, a device, a readable storage medium and a product for rendering a live streaming effect. The method includes: obtaining a live streaming image frame corresponding to a virtual reality live streaming content and a predetermined target effect; determining key point information corresponding to at least part of a target object in the live streaming image frame; performing an effect rendering operation on the live streaming image frame according to the target effect and the key point information to obtain a target image frame; displaying the target image frame. Therefore, the effect processing region may be centered on the positions associated with the key point information, the region needing effect processing is effectively reduced, and the effect processing efficiency is improved.

This application claims the priority to Chinese Patent Application No. 202211612984X, filed Dec. 15, 2022, and entitled “Method, Apparatus, Device, Readable Storage Medium and Product for Rendering Live Streaming Effect”, the entirety of which is incorporated herein by reference.

### FIELD

The embodiment of the disclosure relates to the technical field of image processing, in particular to a method, an apparatus, a device, a readable storage medium and a product for rendering a live streaming effect.

### BACKGROUND

The VR panoramic live streaming is generally collected in real time by using a binocular camera. The VR live streaming generally adopts a 8k video frame (7680*4320) or more, and compared with the traditional 2K (2048*unspecified value), 720 P (1280*720), which belongs to an ultrahigh definition video frame. Due to the requirement of the time delay in the live streaming process, the time actually reserved for the effect rendering is relatively short. Therefore, the algorithm and the effect rendering of the 8k picture needs to be completed within a limited time, to ensure a good experience of the VR live streaming. How to ensure rapid effect rendering in the VR live streaming process becomes a technical problem to be solved.

### SUMMARY

The embodiment of the disclosure provides a method, an apparatus, a device, a readable storage medium and a product for rendering a live streaming effect, for solving the technical problem that in a VR live streaming scene, the effect rendering speed of the collected ultrahigh definition video frame is slow, and the live streaming effect cannot be guaranteed.

In a first aspect, an embodiment of the disclosure provides a method for rendering a live streaming effect, comprising:
obtaining a live streaming image frame corresponding to a virtual reality live streaming content and a predetermined target effect;
determining key point information corresponding to at least part of a target object in the live streaming image frame;
performing an effect rendering operation on the live streaming image frame according to the target effect and the key point information to obtain a target image frame;
displaying the target image frame.

In a second aspect, an embodiment of the disclosure provides an apparatus for rendering a live streaming effect, characterized by comprising:
an obtaining module configured to obtain a live streaming image frame corresponding to a virtual reality live streaming content and a predetermined target effect;
a determination module configured to determine key point information corresponding to at least part of a target object in the live streaming image frame;
a rendering module configured to perform an effect rendering operation on the live streaming image frame according to the target effect and the key point information to obtain a target image frame;
a display module configured to display the target image frame.

In a third aspect, an embodiment of the disclosure provides an electronic device, comprising: a processor and a memory;
the memory storing computer executable instructions;
the processor executing the computer executable instructions stored in the memory, to enable the processor to execute a method for rendering a live streaming effect according to the above first aspect and various possible designs thereof.

In a fourth aspect, an embodiment of the disclosure provides a computer-readable storage medium. The computer-readable storage medium stores computer-executable instructions which, when executed by a processor, implement a method for rendering a live streaming effect according to the above first aspect and various possible designs thereof.

In a fifth aspect, an embodiment of the disclosure provides a computer program product comprising a computer program, the computer program, when executed by a processor, implements a method for rendering a live streaming effect according to the above first aspect and various possible designs thereof.

According to the method, apparatus, device, readable storage medium and product for rendering a live streaming effect provided by the embodiment, after obtaining a live streaming image frame corresponding to a virtual reality live streaming content, key point information in the live streaming image frame is obtained. The effect rendering operation is performed on the position associated with the key point information in the live streaming image frame according to the key point information, so that the region needing effect processing is centered on the position associated with the key point information, the region needing effect processing is effectively reduced, and then the effect processing efficiency can be improved.

### BRIEF DESCRIPTION OF DRAWINGS

In order to more clearly illustrate the embodiments of the disclosure or the technical solutions in the prior art, the accompanying drawings used in the description of the embodiments or the prior art will be briefly introduced below, and it will be apparent that the drawings in the following description are some embodiments of the disclosure, and those skilled in the art may also obtain other drawings according to these drawings without creative labor.

FIG. 1 is a schematic diagram of a system architecture on which the disclosure based;

FIG. 2 is a schematic flowchart of a method for rendering a live streaming effect according to an embodiment of the disclosure;

FIG. 3 is a schematic diagram of external expansion according to an embodiment of the disclosure;

FIG. 4 is a schematic flowchart of a method for rendering a live streaming effect according to another embodiment of the disclosure;

FIG. 5 is a schematic diagram of an application scenario according to an embodiment of the disclosure;

FIG. 6 is a schematic flowchart of a method for rendering a live streaming effect according to still another embodiment of the disclosure;

FIG. 7 is a schematic flowchart of a method for rendering a live streaming effect according to still another embodiment of the disclosure;

FIG. 8 is a schematic diagram of interface interaction according to an embodiment of the disclosure;

FIG. 9 is a schematic diagram of another interface interaction according to an embodiment of the disclosure;

FIG. 10 is a schematic diagram of still another interface interaction according to an embodiment of the disclosure;

FIG. 11 is a schematic structural diagram of an apparatus for rendering a live streaming effect according to an embodiment of the disclosure;

FIG. 12 is a schematic structural diagram of an electronic device according to an embodiment of the disclosure.

### DETAILED DESCRIPTION

In order to make the objectives, technical solutions and advantages of the embodiments of the disclosure clearer, the technical solutions in the embodiments of the disclosure will be clearly and completely described below with reference to the accompanying drawings in the embodiments of the disclosure. All other embodiments obtained by those skilled in the art based on the embodiments of the disclosure without creative efforts shall fall within the scope of the disclosure.

In order to solve the technical problem of slow rendering speed and inability to guarantee live streaming effects for ultra definition video frames collected in VR live streaming scenes, this disclosure provides a method, an apparatus, a device, a readable storage medium and a product for rendering a live streaming effect.

It should be noted that the method, apparatus, device, readable storage medium and product for rendering a live streaming effect provided by the disclosure may be applied to a scene of image rendering in any VR scene.

The existing VR panoramic live streaming is generally collected in real time by using a binocular camera, and generally adopts 8k video frame (7680*4320) or more, and compared with the traditional 2K (2048*unspecified value), 720P (1280*720), it belongs to an ultrahigh definition video frame. The 8K single frame data amount is 7680*4320*4Byte=126 MB, the live streaming frame rate generally requires 30-60 fps, the single frame time delay upper limit is 16 ms-33 ms, the time window actually reserved for effect rendering may be shorter, thus the algorithm and effect rendering of the 8k picture needs to be completed within a limited time, to ensure the good experience of VR live streaming.

In the process of solving the technical problem, the inventor finds that in order to improve the speed of effect rendering and ensure the good experience of VR live streaming, a graphics processor may be adopted to perform effect rendering, and a central processing unit is adopted for recognition and detection. In order to further improve the effect rendering speed, the range of the effect rendering may be centered on or around the streamer, so that the pixel region actually required to be processed may be reduced. In addition, since the data amount of the live streaming image frame is large, it is necessary to avoid the time-consuming data transmission between the cpu and the gpu. Therefore, before the live streaming image frame acquired by the graphics processor is sent to the central processing unit, the live streaming image frame may be subjected to a compression and/or a clipping to reduce the data transmission amount and improve the transmission speed.

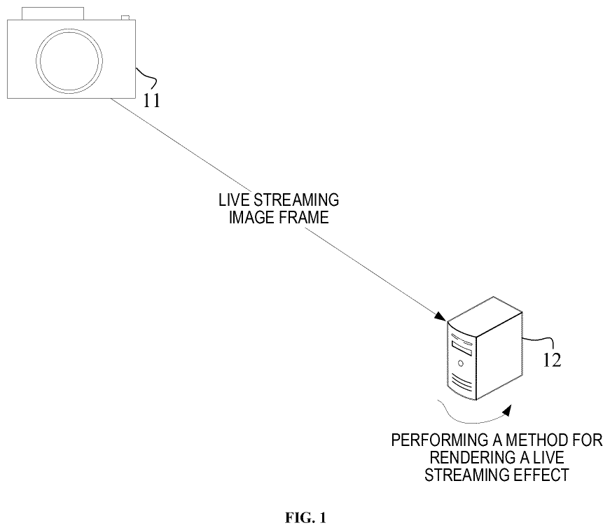

FIG. 1 is a schematic diagram of a system architecture on which the disclosure based. As shown in FIG. 1, the system architecture on which the disclosure based comprises at least: a binocular image collecting apparatus 11 and a server 12. The server 12 is provided with a graphics processor and a central processing unit, both of which are provided with an apparatus for rendering a live streaming effect. The apparatus for rendering a live streaming effect may be written in a language such as C/C++, Java, Shell or Python.

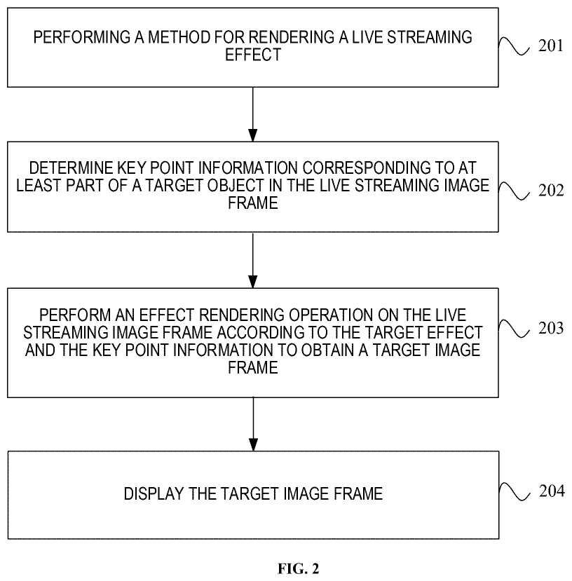

FIG. 2 is a schematic flowchart of a method for rendering a live streaming effect according to an embodiment of the disclosure. As shown in FIG. 2, the method comprises:
Step 201: obtaining a live streaming image frame corresponding to a virtual reality live streaming content and a predetermined target effect.

The execution body of this embodiment is an apparatus for rendering a live streaming effect, which may be coupled to a server. A graphics processor and a central processing unit are respectively disposed in the server.

In this implementation, when a user performs a virtual reality (VR) live streaming, content such as an effect, a beautification and a filter may be selected according to actual needs, to improve a live streaming result. When the target effect selected by the user is obtained, the effect rendering operation needs to be performed on the live streaming content according to the target effect, so as to obtain a modification result.

In VR live streaming, in order to ensure a live streaming effect, a binocular image collecting apparatus is used to collect live streaming content, and a live streaming image frame collected by a binocular image collecting apparatus is usually a 8k image frame (7680*4320) or more, a size is large, and an effect rendering process consumes a long time.

Correspondingly, to implement the effect rendering on the live streaming content, the apparatus for rendering a live streaming effect may obtain the live streaming image frame corresponding to the virtual reality live streaming content. The live streaming image frame may be collected at a predetermined time interval, or the live streaming image frame may be collected at a predetermined frequency, which is not limited in this disclosure. The live streaming image frame may be specifically collected by a binocular image collecting apparatus, or may be collected by another image collecting apparatus capable of supporting virtual reality live streaming content collection, which is not limited in this disclosure.

Correspondingly, in order to implement the effect rendering on the live streaming image frame, and to obtain a predetermined target effect, the target effect may be selected by the user according to actual needs in the live streaming process.

Step 202: determining key point information corresponding to at least part of a target object in the live streaming image frame.

In this implementation, in order to improve the speed of the effect rendering and avoid the lag in the live streaming process, the effect rendering operation may be focused on at least part of the target object in the live streaming image frame. The target object may be a person, an animal, a specific object, or the like in the live streaming image frame.

Therefore, after obtaining the live streaming image frame, the key point information corresponding to at least part of the target object in the live streaming image frame may be determined. Optionally, key point information corresponding to at least part of the target object in the live streaming image frame may be determined according to a predetermined detection algorithm. The key point information may specifically be coordinate information of a key position in the target object.

Step 203: performing an effect rendering operation on the live streaming image frame according to the target effect and the key point information to obtain a target image frame.

In this implementation, after obtaining the key point information, the target effect may be used to perform the effect rendering on the live streaming image frame according to the key point information to obtain the target image frame. Therefore, effect rendering is not needed for all positions of the live streaming image frame. The effect rendering efficiency is improved, while the display effect of the target object is optimized.

Step 204: displaying the target image frame.

In this implementation, after the effect rendering is performed on the live streaming image frame to obtain the target image frame, the target image frame may be displayed.

Optionally, the target image frame is distributed to a predetermined terminal device for display. The predetermined terminal device may be at least part of the virtual reality device through which the VR live streaming can be viewed, so that the user views the virtual reality live streaming by using the virtual display device.

Alternatively, if the apparatus for rendering a live streaming effect is coupled into the terminal device, the predetermined display interface of the terminal device may be directly controlled to display the target image frame.

It should be noted that, both the graphics processor and the central processing unit are provided in the server. The graphics processor may be used to perform the effect rendering, and the central processing unit is used to recognize the key points. Alternatively, the central processing unit may be used to perform effect rendering, and the graphics processor may be used to recognize the key points. This is not limited in the disclosure.

According to the method for rendering a live streaming effect provided by the embodiment, after the live streaming image frame corresponding to the virtual reality live streaming content is obtained, the key point information in the live streaming image frame is determined, and the effect rendering is performed on the position associated with the key point information in the live streaming image frame according to the key point information, so that the region needing effect processing is centered at the position associated with the key point information, the region needing effect processing is effectively reduced, and then the effect processing efficiency can be improved.

In practical applications, different target effects may correspond to different display result, and correspondingly also have different rendering positions. For example, a rendering position corresponding to an effect such as beauty, a sticker for a face, and a decoration on a head may be a face or a head. The rendering position corresponding to the effect for the filter and the global display is the entire live streaming image frame. Therefore, different rendering modes may be used for rendering for different target effects.

Optionally, based on any of the foregoing embodiments, step 203 comprises:
determining a target region in which at least part of the target object is located in the live streaming image frame according to the key point information corresponding to the at least part of the target object.
in accordance with a determination that the target effect is a locally applied effect, for at least part of the target region, performing a local rendering on the target region according to the target effect to obtain a rendering result of the target region.
for at least part of the target region, covering the live streaming image frame with the rendering result of target region to obtain the target image frame.

In this embodiment, the target effect may be specifically a locally applied effect. For example, it may be a beauty effect, which is an effect applied only to a face. Alternatively, it may be a headwear effect, which may be an effect acting only on the head. Therefore, for the foregoing locally applied effect, the effect rendering may be performed only on the target region, and effect rendering may be not performed on other positions in the live streaming image frame. Therefore, the region with effect processing performed can be centered at the position associated with the key point information, the range of effect rendering is effectively reduced, and the speed of effect rendering is improved.

Specifically, when the target effect is a locally applied effect, a local rendering may be performed on each target region according to the target effect to obtain a target region rendering result. After the effect rendering is completed, the target region rendering result may be overlaid onto the live streaming image frame to obtain the target image frame.

Further, on the basis of any of the above embodiments, performing the local rendering operation on the target region according to the target effect comprises:
in response to detecting that the target effect meets a predetermined external expansion condition, performing an external expansion on the target region according to a predetermined region external expansion algorithm to obtain a region to be rendered;
performing a local rendering on the region to be rendered according to the target effect.

In this embodiment, to ensure the rendering effect of the edge of the target region, an external expansion may be performed on the target region. Specifically, if it is detected that the target effect meets the predetermined external expansion condition, an external expansion is performed on the target region according to a predetermined region external expansion algorithm to obtain a region to be rendered. The predetermined external expansion condition may be an external expansion may be performed when the target effect is an effect acting on the face or other predetermined positions. A local rendering is performed on the region to be rendered after external expansion according to the target effect.

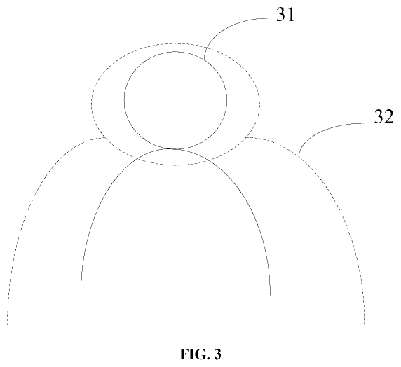

FIG. 3 is a schematic diagram of external expansion provided by an embodiment of the disclosure. As shown in FIG. 3, in order to obtain a better rendering effect, after obtaining the target region 31, an external expansion may be performed on the target region 31 to obtain the region 32 to be rendered.

According to the method for rendering a live streaming effect provided by the embodiment, an external expansion is performed on the target region when the target effect meets the predetermined external expansion condition, so that the result of effect rendering can be improved, and the live streaming quality is improved.

Optionally, based on any of the foregoing embodiments, step 203 comprises:
in accordance with a determination that the target effect is a globally applied effect, performing an effect rendering on the live streaming image frame according to the target effect to obtain the target image frame.

In this embodiment, the target effect may further comprise an effect applied to the global, such as a filter, raindrops displayed globally, and the like. Therefore, when the target effect is a globally applied effect, the effect rendering may be performed on the live streaming image frame according to the target effect to obtain the target image frame.

According to the method for rendering a live streaming effect provided by the embodiment, the effect rendering is performed on the position associated with the key point information in the live streaming image frame according to the key point information. Thus, the region needing effect processing is centered on the position associated with the key point information, the region needing effect processing is effectively reduced, and then the effect processing efficiency can be improved.

It should be noted that the server is respectively provided with a graphics processor and a central processing unit, thus based on the processing property of different processors, the central processing unit may be used to perform the recognition of the key points, and the graphics processor is used to perform effect rendering based on the key point information.

Further, on the basis of any of the above embodiments, step 202 comprises:
determining, by a predetermined central processing unit, key point information corresponding to at least part of the target object in the live streaming image frame;

the step 203 comprises:
performing, by a predetermined graphics processor, an effect rendering on the live streaming image frame according to the target effect and the key point information, to obtain the target image frame.

In this embodiment, the graphics processor is in communication connection with the central processing unit and the binocular image collecting apparatus, so that the live streaming image frame collected by the binocular image collecting apparatus can be obtained, the detection is performed by the central processing unit, and the effect rendering is performed by the graphics processor.

Therefore, after obtaining the live streaming image frame, the graphics processor may send the live streaming image frame to the central processing unit. Correspondingly, after obtaining the live streaming image frame, the central processing unit may determine key point information corresponding to at least part of the target objects in the live streaming image frame according to a predetermined detection algorithm, where the key point information may specifically be coordinate information of a key position in the target object. The key point information is fed to the graphics processor.

After obtaining the key point information, the graphics processor may perform a rendering on the live streaming image frame by using a rendering mode corresponding to the target effect according to the key point information.

According to the method for rendering a live streaming effect provided by the embodiment, after the live streaming image frame corresponding to the virtual reality live streaming content is obtained, the central processing unit is used to calculate the key point information in the live streaming image frame, and the graphics processor is used to perform effect rendering on the position associated with the key point information in the live streaming image frame according to the key point information. In such way, the region needing effect processing is centered on the position associated with the key point information, the region needing effect processing is effectively reduced, and then the effect processing efficiency can be improved. In addition, the effect processing is performed by the graphics processor, so that a large amount of transmission of the live streaming image frame can be effectively avoided, the time consumption of data transmission is reduced, and the efficiency of effect processing can be further improved.

Further, on the basis of any of the above embodiments, step 202 comprises:
performing a size adjustment on the live streaming image frame to obtain an adjusted live streaming image frame.
determining, by a central processing unit, key point information corresponding to at least part of the target object in the adjusted live streaming image frame.

In this embodiment, since the live streaming image frame is generally 8K (7680*4320) or more, the size is large. Therefore, the key point recognition based on the live streaming image frame is time-consuming. In order to ensure the live streaming result, before the recognition of the key point information of the live streaming image frame, the size of the live streaming image frame may be adjusted to obtain the adjusted live streaming image frame. The size adjustment may be a size scaling on the live streaming image frame, for example, the live streaming image frame is scaled to the image frame of 1K, and then the recognition efficiency of the key point is higher based on the adjusted live streaming image frame.

Further, since the server is respectively provided with a graphics processor and a central processing unit, the central processing unit may be used to recognize the key point information. In addition, the live streaming image frame may be obtained by the graphics processor, or the live streaming image frame may be obtained by using the central processing unit, or may be set by the user according to actual requirements, the execution body for obtaining the live streaming image frame is not limited in this embodiment.

Therefore, after adjusting the size of the live streaming image frame to obtain the adjusted live streaming image frame, key point information corresponding to at least part of the target object in the adjusted live streaming image frame may be determined by the central processor.

According to the method for rendering a live streaming effect provided by the embodiment, after the live streaming image frame corresponding to the virtual reality live streaming content is obtained, the size of live streaming image frame is adjusted, and the key point information in the live streaming image frame is calculated by the central processing unit. Thus, the calculation amount in the key point recognition process can be effectively reduced, and the rendering efficiency of the live streaming image frame is improved. Therefore, the virtual reality live streaming can be ensured to be smooth and unstuck, and the user experience is improved.

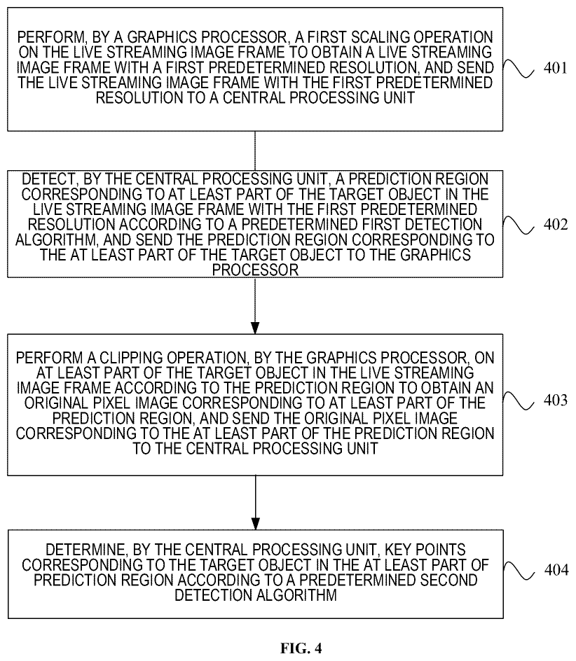

FIG. 4 is a schematic flowchart of a method for rendering a live streaming effect according to another embodiment of the disclosure. On the basis of any of the above embodiments, as shown in FIG. 4, step 202 comprises:
Step 401: performing, by a graphics processor, a first scaling operation on the live streaming image frame to obtain a live streaming image frame with a first predetermined resolution, and sending the live streaming image frame with the first predetermined resolution to a central processing unit.
Step 402: detecting, by the central processing unit, a prediction region corresponding to at least part of the target object in the live streaming image frame with the first predetermined resolution according to a predetermined first detection algorithm, and sending the prediction region corresponding to the at least part of the target object to the graphics processor.
Step 403: clipping, by the graphics processor, at least part of the target object in the live streaming image frame according to the prediction region to obtain an original pixel image corresponding to at least part of the prediction region, and sending the original pixel image corresponding to the at least part of the prediction region to the central processing unit.
Step 404: determining, by the central processing unit, key points corresponding to the target object in the at least part of prediction region according to a predetermined second detection algorithm.

In this embodiment, since the pixel values of the live streaming image frame are generally (7680*4320) or more, and the single frame data amount is 7680*4320*4Byte=126 MB, the transmission duration of the live streaming image frame is also relatively long.

Optionally, the graphics processor may obtain the live streaming image frame and the perform an effect rendering operation, and the central server may perform the recognition of the key point information. Therefore, after the graphics processor obtains the live streaming image frame, the live streaming image frame needs to be sent to the central processing unit for key point detection, in order to improve the speed of the effect rendering, the data amount of the transmitted data can be reduced in the data transmission process. Specifically, the graphics processor may perform a first scaling operation on the live streaming image frame to obtain a live streaming image frame with a first predetermined resolution, and may send the live streaming image frame with the first predetermined resolution to the central processing unit. In practical applications, the corresponding first predetermined resolution may be set according to actual requirements, which is not limited in the disclosure. For example, the live streaming image frame of 8K may be scaled to the live streaming image frame of 1k.

After the central processing unit obtains the live streaming image frame with the first predetermined resolution, because the content definition in the live streaming image frame with the first predetermined resolution is lower than the original live streaming image frame, the central processing unit may perform coarse granularity prediction on the region in which the target object in the live streaming image frame with the first predetermined resolution is located, to obtain a prediction region corresponding to at least part of target object in the live streaming image frame with the first predetermined resolution. The predicted region corresponding to at least part of the target object in the live streaming image frame with the first predetermined resolution is sent to the graphics processor.

After obtaining the prediction region corresponding to the at least part of the target object, the graphics processor may directly perform the effect rendering on the prediction region to obtain the target image frame. Optionally, in order to further improve the precision of the effect rendering, the graphics processor may further clip the target object according to the prediction region corresponding to the at least part of the target object to obtain the original pixel image corresponding to the at least part of prediction region. The pixels of the original pixel image are the same as the live streaming image frames. Since the size of the original pixel image is much smaller than the size of the live streaming image frame, the transmission speed is faster when transmitting to the central processing unit.

Correspondingly, after obtaining the at least part of the original pixel image, the central processing unit may recognize the key point information of the target object in the original pixel image to obtain key point information of at least part of the target object, and feed back the key point information to the graphics processor. When the target object is a person, the key point information may be coordinate information of key positions such as a head and a facial feature of the person.

FIG. 5 is a schematic diagram of an application scenario according to an embodiment of the disclosure. As shown in FIG. 5, the graphics processor 51 may perform a first scaling operation on the live streaming image frame 52 to obtain a live streaming image frame 53 with a first predetermined resolution, and transmit the live streaming image frame 53 with the first predetermined resolution to the central processing unit 54. The central processing unit 54 may detect the predicted region of the live streaming image frame 53 with the first predetermined resolution to obtain the predicted region 55 corresponding to at least part of the target object in the live streaming image frame. The prediction region 55 corresponding to at least part of the target object in the live streaming image frame is sent to the graphics processor 51. Thus, the graphics processor 51 may clip the prediction region 55 corresponding to at least part of the target object in the live streaming image frame, and send the clipped original pixel image 56 corresponding to the at least part of prediction region to the central processing unit 54. The central processing unit 54 may detect the key points in the original pixel image 56 corresponding to the at least part of the prediction region, and feed the key points to the graphics processor 51. Therefore, the graphics processor 51 performs the effect rendering on the live streaming image frame according to the key point information to obtain the target image frame.

Further, on the basis of any of the above embodiments, step 404 comprises:
performing, by the graphics processor, a second scaling operation on the original pixel image corresponding to the at least part of prediction region, to obtain an original pixel image with a second predetermined resolution corresponding to the at least part of prediction region;
sending the original pixel image with the second predetermined resolution corresponding to the at least part of prediction region to the central processing unit.

In this embodiment, in order to further improve the speed of image transmission, before transmitting the original pixel image, the original pixel image may be subjected to a second scaling operation to obtain the original pixel image with the second predetermined resolution corresponding to the at least part of prediction region. The scaling scale of the second scaling operation is smaller than that of the first scaling operation, that is, the second predetermined resolution is greater than the first predetermined resolution. The original pixel image with the second predetermined resolution corresponding to the at least part of prediction region is sent to the central processing unit.

According to the method for rendering a live streaming effect provided by the embodiment, in the data transmission process, the scaled live streaming image frame with the first predetermined resolution is sent to the central processing unit, and the clipped original pixel image corresponding to the at least part of prediction region is sent to the central processing unit. In such way, the data amount of data transmission can be effectively reduced, the data transmission speed between the graphics processor and the central processing unit is increased, and the effect rendering speed in the VR live streaming scene can be improved.

Further, on the basis of any of the above embodiments, step 402 comprises:
detecting a target object in the live streaming image frame with the first predetermined resolution according to the predetermined first detection algorithm, to determine a first region where at least part of the target object is located;
determining, for at least two first regions meeting a predetermined merging condition, whether a size of a merged region after merging the at least two first regions is greater than a size before merging the at least two first regions;
if yes, determining the first region as the prediction region;
if not, determining the merged region as the prediction region.

In this embodiment, in the process of generating the prediction region, in order to reduce the calculation amount of the subsequent effect rendering, the regions meeting a predetermined merging condition may be merged. Specifically, the target object in the live streaming image frame with the first predetermined resolution may be detected by a predetermined first detection algorithm, to determine a first region where the at least part of the target object is located.

It is determined whether at least part of the first regions meet a predetermined merging condition. The predetermined merging condition comprises, but is not limited to, a distance between the at least two first regions being less than a predetermined distance threshold, the at least two first regions intersecting, a coverage region of any first region being larger while the coverage region of surrounding first regions being smaller.

For at least two first regions meeting a predetermined merging condition, it is determined whether a size of a merged region after merging the at least two first regions is greater than a size before merging the at least two first regions. If yes, the first region is determined as the prediction region; otherwise, the merged region is determined as the prediction region.

According to the method for rendering a live streaming effect provided in this embodiment, a graphics processor is used to perform effect rendering, and a central processing unit is used to perform recognition and detection. In order to further improve the effect rendering speed, the range of the effect rendering may be centered on or around the streamer, so that the pixel region actually required to be processed can be reduced, and the effect processing efficiency can be improved.

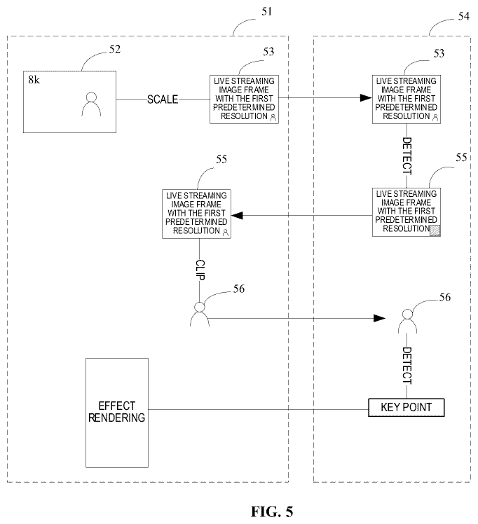

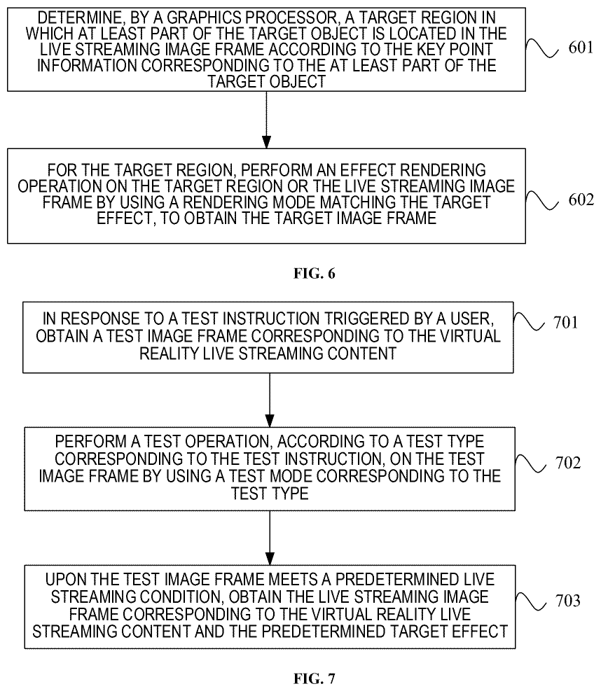

FIG. 6 is a schematic flowchart of a method for rendering a live streaming effect according to still another embodiment of the disclosure. On the basis of any of above embodiments, the key point information comprises coordinate information of a plurality of key points corresponding to a target object. As shown in FIG. 6, step 203 comprises:
Step 601: determining, by a graphics processor, a target region in which at least part of the target object is located in the live streaming image frame according to the key point information corresponding to the at least part of the target object;
Step 602: for the target region, performing an effect rendering on the target region or the live streaming image frame by using a rendering mode matching the target effect, to obtain the target image frame.

In this embodiment, in order to improve the speed of the effect rendering of the live streaming image frame and guarantee the live streaming result, the region of the effect processing may be centered on the position associated with the key point information.

Therefore, after obtaining the key point information corresponding to the at least part of the target objects, the graphics processor may determine, based on the key point information corresponding to the at least part of the target object, a target region in which at least part of the target object in the live streaming image frame are located. For each target region, an effect rendering may be performed on the target region or the live streaming image frame according to the rendering mode corresponding to the target effect predetermined by the user to obtain the target image frame.

According to the method for rendering a live streaming effect provided by the embodiment, the rendering region is centered around the target region, so that the effect rendering efficiency can be improved.

Further, on the basis of any of the above embodiments, before step 201, the following are further comprised:
obtaining, by a graphics processor, an original image frame corresponding to a virtual reality live streaming content collected by a binocular image collecting apparatus, and performing a hardware decoding and a format conversion on the original image frame to obtain the live streaming image frame.

In this embodiment, in order to further improve the speed of the effect rendering, avoid too much information interaction between the graphics processor and the central processing unit, the preprocessing of the original image frame may be put in the graphics processor for processing.

Correspondingly, the apparatus for rendering a live streaming effect may obtain the original image frame corresponding to the virtual reality live streaming content collected by the binocular image collecting apparatus. A hardware decoding and a format conversion are performed on the original image frame to obtain a live streaming image frame.

According to the method for rendering a live streaming effect provided by the embodiment, the preprocessing of the original image frame is put in the graphics processor for processing, so that the time delay caused by excessive transmission of the live streaming image frame can be effectively avoided, and the rendering speed of the live streaming image frame is improved.

FIG. 7 is a schematic flowchart of a method for rendering a live streaming effect according to still another embodiment of the disclosure. On the basis of any of the above embodiments, as shown in FIG. 7, before step 201, the following are further comprised:
Step 701: in response to a test instruction triggered by a user, obtaining a test image frame corresponding to the virtual reality live streaming content.
Step 702: testing, according to a test type corresponding to the test instruction, the test image frame by using a test mode corresponding to the test type.

The step 201 comprises:
Step 703: upon the test image frame meets a predetermined live streaming condition, obtaining the live streaming image frame corresponding to the virtual reality live streaming content and the predetermined target effect.

In this embodiment, in order to guarantee the live streaming result of the virtual reality live streaming, before the effect rendering is performed on the live streaming image frame corresponding to the virtual reality live streaming, the current live streaming effect needs to be tested firstly.

Optionally, a predetermined test control may be displayed on the live streaming display interface, and the user may trigger the test control according to actual needs. In response to the test instruction triggered by the user triggering the test control, a test image frame corresponding to the virtual reality live streaming content may be obtained. The test image frame may be an image frame collected by a predetermined binocular image collecting apparatus, and the test image frame may be composed of an image frame collected by a left image collecting apparatus in the binocular image collecting apparatus and an image frame combination collected by a right image collecting apparatus in the binocular image collecting apparatus.

Further, in order to guarantee the live streaming result, different test types of test operations may be performed on the test image frame. For example, the test type may comprise a first test type and a second test type. The first test type may be a brightness test, and the brightness test is performed on the test image frame, thereby ensuring the viewing effect of the live streaming image frame. The second test type may be a focusing test to ensure the definition of the live streaming image frame.

Different test modes may be predetermined for different test types. After the current test type is determined, the test image frame may be tested in a test mode corresponding to the test type.

After completing the test on the test image frame, a test result may be obtained. After the test result is obtained, if it is detected that the test result meets the predetermined live streaming condition, the live streaming image frame corresponding to the virtual reality live streaming content and the predetermined target effect are obtained.

FIG. 8 is a schematic diagram of interface interaction according to an embodiment of the disclosure. As shown in FIG. 8, the live streaming display interface 81 may display a predetermined test controls 82. In response to the trigger performed by the user on the test control 82, the test image frame 83 and the test result 84 may be displayed in the predetermined display region of the live streaming display interface 81.

According to the method for rendering a live streaming effect provided by the embodiment, before the effect rendering is performed on the live streaming image frame, the test image frame is firstly tested. Thus, the display effect of the virtual reality live streaming can be effectively guaranteed, and then the user experience can be improved.

Optionally, based on any of the foregoing embodiments, the test type comprises a first test type, and step 702 comprises:
performing a brightness detection on the test image frame by a brightness detection algorithm corresponding to the first test type to obtain a brightness detection result.

In this embodiment, the test type comprises a first test type, the first test type may be a brightness test. A brightness test is performed on the test image frame, thereby ensuring a viewing effect of the live streaming image frame.

Optionally, a predetermined brightness test control may be displayed on the live streaming display interface, and the user may trigger the brightness test control to trigger the test operation of the first test type. When it is determined that the type of the current test operation is the first test type, the brightness detection may be performed on the test image frame through the brightness detection algorithm corresponding to the first test type to obtain the brightness detection result.

The brightness detection of the test image frame may be implemented by any algorithm capable of realizing brightness detection, which is not limited in the disclosure.

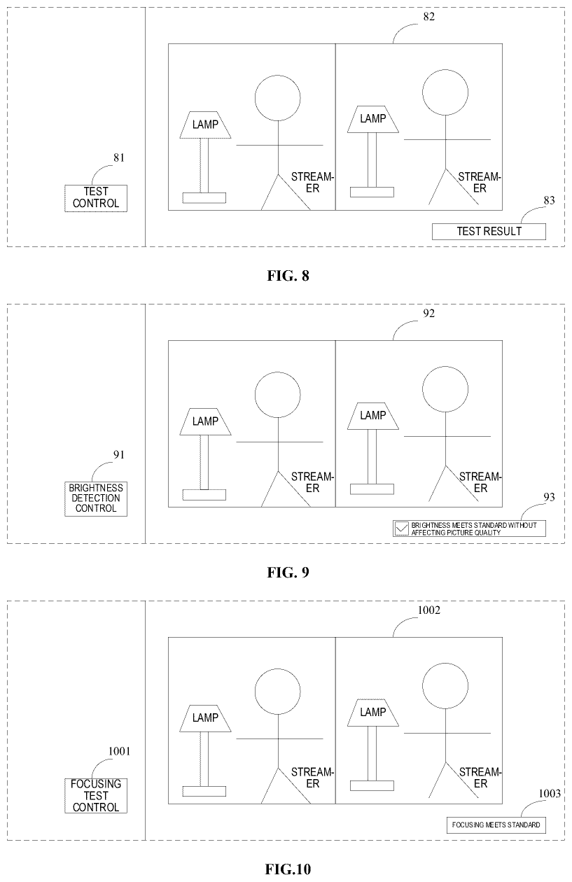

FIG. 9 is a schematic diagram of still another interface interaction according to an embodiment of the disclosure. As shown in FIG. 9, the live streaming display interface 91 may display the predetermined brightness test control 92. In response to the trigger performed by the user on the brightness test control 92, the test image frame 93 and the brightness test result 94 may be displayed in the predetermined display region of the live streaming display interface 91.

Further, on the basis of any of the above embodiments, after performing the brightness detection on the test image frame through the brightness detection algorithm corresponding to the first test type to obtain the brightness detection result, the method further comprises:
in response to detecting that the brightness detection result meets a predetermined live streaming condition, obtaining a live streaming image frame corresponding to the virtual reality live streaming content and a predetermined target effect;
in response to detecting that the brightness detection result does not meet the predetermined live streaming condition, displaying a predetermined first prompt for prompting the user to adjust the brightness of the current position to a predetermined brightness threshold.

In this embodiment, after the brightness detection result is obtained, if it is detected that the brightness detection result meets the predetermined live streaming condition, the live streaming image frame corresponding to the virtual reality live streaming content and the predetermined target effect are obtained, so as to perform a subsequent effect rendering on the live streaming image frame. Optionally, if it is detected that the brightness detection result meets the predetermined live streaming condition, prompt indicating that the test is successful may also be displayed, to prompt the user to perform a subsequent live streaming operation. On the contrary, if it is detected that the brightness detection result does not meet the predetermined live streaming condition, the predetermined first prompt is displayed, which is used to prompt the user to adjust the brightness of the current position to a predetermined brightness threshold. For example, the first prompt may specifically be that the current brightness is insufficient, please adjust the light in the room to 600 lumens.

According to the method for rendering a live streaming effect provided by the embodiment, the brightness of the test image frame is detected before the effect rendering is performed on the live streaming image frame, and the subsequent live streaming image frame rendering is carried out when the brightness meets the predetermined live streaming condition, so that the live streaming effect of the virtual reality live streaming can be guaranteed.

Optionally, based on any of the foregoing embodiments, the test type comprises a second test type, and step 702 comprises:
detecting the test image frame by a focusing test algorithm corresponding to the second test type to obtain a focusing detection result.

In this embodiment, the test type comprises a second test type, and the second test type may be a focusing test to ensure the definition of the live streaming image frame. When it is determined that the current test type is the second test type, the test image frame may be detected by the focusing test algorithm corresponding to the second test type to obtain the focusing detection result. The test image frame may be tested by any algorithm that can implement focusing detection, which is not limited in the disclosure.

FIG. 10 is a schematic diagram of still another interface interaction according to an embodiment of the disclosure. As shown in FIG. 10, the live streaming display interface 1001 may display the predetermined focusing test control 1002. In response to the trigger performed by the user on the focusing test control 1002, the test image frame 1003 and the focusing test result 1004 may be displayed in the predetermined display region of the live streaming display interface 1001.

Further, on the basis of any of the above embodiments, after detecting the test image frame by the focusing test algorithm corresponding to the second test type to obtain the focusing detection result, the method further comprises:
in response to detecting that the focusing detection result meets a predetermined live streaming condition, obtaining a live streaming image frame corresponding to the virtual reality live streaming content and a predetermined target effect;
in response to detecting that the focusing detection result does not meet the predetermined live streaming condition, displaying a predetermined second prompt for prompting the user to reperform a focusing operation.

In this embodiment, if it is detected that the focusing detection result meets the predetermined live streaming condition, the live streaming image frame corresponding to the virtual reality live streaming content and the predetermined target effect are obtained to perform subsequent effect rendering on the live streaming image frame. Optionally, if it is detected that the focusing detection result meets the predetermined live streaming condition, prompt indicating that the test is successful may also be displayed, to prompt the user to perform a subsequent live streaming operation. On the contrary, if it is detected that the focusing detection result does not satisfy the predetermined live streaming condition, the predetermined second prompt is displayed, and the second prompt is used to prompt the user to reperform the focusing operation.

Optionally, the adjustment mode may also be determined according to the focusing detection result, and the adjustment mode is displayed in the second prompt. Thus, the user may perform focusing adjustment according to the adjustment mode. For example, the second prompt may be: focusing fails, the left camera is adjusted backwards.

According to the method for rending a live streaming effect provided in this embodiment, before the effect rendering is performed on the live streaming image frame, whether the test image frame is in focus is detected. If it is detected that the focusing detection result meets the predetermined live streaming condition, the live streaming image frame corresponding to the virtual reality live streaming content and the predetermined target effect are obtained to perform subsequent effect rendering operations on the live streaming image frame. Therefore, the definition of the live streaming image frame can be ensured, and the user experience is further improved.

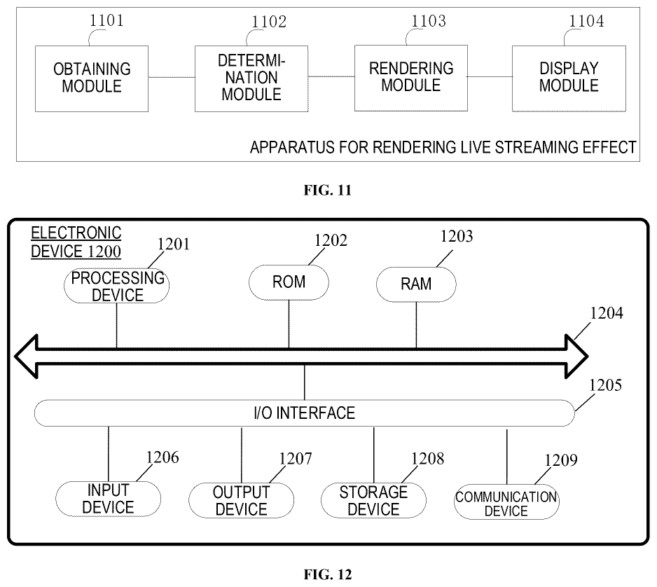

FIG. 11 is a schematic structural diagram of an apparatus for rendering a live streaming effect provided by an embodiment of the disclosure, applied to the graphics processor. As shown in FIG. 11, the apparatus comprises an obtaining module 1101, a determination module 1102, a rendering module 1103, and a display module 1104. The obtaining module 1101 is configured to obtain a live streaming image frame corresponding to a virtual reality live streaming content and a predetermined target effect. The determination module 1102 is configured to determine key point information corresponding to at least part of a target object in the live streaming image frame. The rendering module 1103 is configured to perform an effect rendering operation on the live streaming image frame according to the target effect and the key point information to obtain a target image frame. The display module 1104 is configured to display the target image frame.

Further, on the basis of any of the above embodiments, the rendering module is configured to: determine a target region in which at least part of the target object is located in the live streaming image frame according to the key point information corresponding to the at least part of the target object. In accordance with a determination that the target effect is a locally applied effect, for at least part of the target region, a local rendering is performed on the target region according to the target effect to obtain a rendering result of the target region. For at least part of the target region, the live streaming image frame is covered with the rendering result of target region to obtain the target image frame.

Further, on the basis of any of the above embodiments, the rendering module is configured to: in response to detecting that the target effect meets a predetermined external expansion condition, perform an external expansion on the target region according to a predetermined region external expansion algorithm to obtain a region to be rendered. A local rendering is performed on the region to be rendered according to the target effect.

Further, on the basis of any of the above embodiments, the rendering module is configured to: in accordance with a determination that the target effect is a globally applied effect, perform an effect rendering on the live streaming image frame according to the target effect to obtain the target image frame.

Further, on the basis of any of the above embodiments, the determination module is configured to: determine, by a predetermined central processing unit, key point information corresponding to at least part of the target object in the live streaming image frame. The rendering module is configured to: perform, by a predetermined graphics processor, an effect rendering operation on the live streaming image frame according to the target effect and the key point information, to obtain the target image frame.

Further, on the basis of any of the above embodiments, the determination module is configured to: perform a size adjustment operation on the live streaming image frame to obtain an adjusted live streaming image frame. By a central processing unit, key point information corresponding to at least part of the target object in the adjusted live streaming image frame is determined.

Further, on the basis of any of the above embodiments, the determination module is configured to: perform, by a graphics processor, a first scaling operation on the live streaming image frame to obtain a live streaming image frame with a first predetermined resolution, and send the live streaming image frame with the first predetermined resolution to a central processing unit. By the central processing unit, a prediction region corresponding to at least part of the target object in the live streaming image frame with the first predetermined resolution is detected according to a predetermined first detection algorithm, and the prediction region corresponding to the at least part of the target object is sent to the graphics processor. By the graphics processor, at least part of the target object in the live streaming image frame is clipped according to the prediction region to obtain an original pixel image corresponding to at least part of the prediction region, and the original pixel image corresponding to the at least part of the prediction region is sent to the central processing unit. By the central processing unit, key points corresponding to the target object in the at least part of prediction region is determined according to a predetermined second detection algorithm.

Further, on the basis of any of the above embodiments, the determination module is configured to: perform, by the graphics processor, a second scaling operation on the original pixel image corresponding to the at least part of prediction region, to obtain an original pixel image with a second predetermined resolution corresponding to the at least part of prediction region; send the original pixel image with the second predetermined resolution corresponding to the at least part of prediction region to the central processing unit.

Further, on the basis of any of the above embodiments, the key point information comprises coordinate information of a plurality of key points corresponding to a target object. The rendering module is configured to: determine, by a graphics processor, a target region in which at least part of the target object is located in the live streaming image frame according to the key point information corresponding to the at least part of the target object. For the target region, an effect rendering is performed on the target region or the live streaming image frame by using a rendering mode matching the target effect, to obtain the target image frame.

Further, on the basis of any of the above embodiments, the apparatus further comprises a preprocessing module, configured to: obtain, by a graphics processor, an original image frame corresponding to a virtual reality live streaming content collected by a binocular image collecting apparatus, and perform a hardware decoding operation and a format conversion operation on the original image frame to obtain the live streaming image frame.

Further, on the basis of any of the above embodiments, the rendering module is configured to: detect a target object in the live streaming image frame with the first predetermined resolution according to the predetermined first detection algorithm, to determine a first region where at least part of the target object is located; for at least two first regions meeting a predetermined merging condition, determine whether a size of a merged region after merging the at least two first regions is greater than a size before merging the at least two first regions. If yes, the first region is determined as the prediction region. If not, the merged region is determined as the prediction region.

Further, on the basis of any of the above embodiments, the apparatus further comprises an obtaining module configured to, in response to a test instruction triggered by a user, obtain a test image frame corresponding to the virtual reality live streaming content;
a test module configured to, according to a test type corresponding to the test instruction, test the test image frame by using a test mode corresponding to the test type. The obtaining module is further configured to: upon the test image frame meets a predetermined live streaming condition, obtain the live streaming image frame corresponding to the virtual reality live streaming content and the predetermined target effect.

Further, on the basis of any of the above embodiments, the test type comprises a first test type. The test module is configured to: perform a brightness detection on the test image frame by a brightness detection algorithm corresponding to the first test type to obtain a brightness detection result.

Further, on the basis of any of the above embodiments, the apparatus further comprises: a processing module configured to, in response to detecting that the brightness detection result meets a predetermined live streaming condition, obtain a live streaming image frame corresponding to the virtual reality live streaming content and a predetermined target effect; the processing module further configured to, in response to detecting that the brightness detection result does not meet the predetermined live streaming condition, display a predetermined first prompt for prompting the user to adjust the brightness of the current position to a predetermined brightness threshold.

Further, on the basis of any of the above embodiments, the test type comprises a second test type. The test module is configured to: detect the test image frame by a focusing test algorithm corresponding to the second test type to obtain a focusing detection result.

Further, on the basis of any of the above embodiments, the apparatus further comprises: the processing module configured to, in response to detecting that the focusing detection result meets a predetermined live streaming condition, obtain a live streaming image frame corresponding to the virtual reality live streaming content and a predetermined target effect; the processing module configured to: in response to detecting that the focusing detection result does not meet the predetermined live streaming condition, display a predetermined second prompt for prompting the user to reperform a focusing operation.

The apparatus provided in this embodiment may be configured to perform the technical solutions in the foregoing method embodiments, and implementation principles and technical effects thereof are similar, and details are not described herein again in this embodiment.

In order to implement the foregoing embodiments, an embodiment of the disclosure further provides an electronic device, comprising: a processor and a memory.

The memory stores computer-executable instructions.

The processor executes the computer executable instruction stored in the memory, to cause the processor executes the method for rendering a live streaming effect according to any of the above embodiments.

FIG. 12 is a schematic structural diagram of an electronic device according to an embodiment of the present disclosure. As shown in FIG. 12, the electronic device 1200 may be a terminal device or a server. The terminal device may comprise, but is not limited to, a mobile terminal such as a mobile phone, a notebook computer, a digital broadcast receiver, a personal digital assistant (PDA), a portable Android device (PAD), a portable media player (PMP), an on-board terminal (for example, an on-board navigation terminal), and a fixed terminal such as a digital TV, a desktop computer, or the like. The electronic device shown in FIG. 12 is merely an example, and should not impose any limitation on the functions and scope of use of the embodiments of the present disclosure.

As shown in FIG. 12, the electronic device 1200 may comprise a processing device (for example, a central processing unit, a graphics processor, etc.) 1201, which may perform various appropriate actions and processing according to a program stored in a read only memory (ROM) 1202 or a program loaded into a random access memory (RAM) 1203 from a storage device 1208. In the RAM 1203, various programs and data required by the operation of the electronic device 1200 are also stored. The processing device 1201, the ROM 1202, and the RAM 1203 are connected to each other through a bus 1204. Input/output (I/O) interface 1205 is also connected to bus 1204.

Generally, the following devices may be connected to the I/O interface 1205: an input device 1206 comprising, for example, a touch screen, a touch pad, a keyboard, a mouse, a camera, a microphone, an accelerometer, a gyroscope, etc.; an output device 1207 comprising, for example, a liquid crystal display (LCD), a speaker, a vibrator, etc.; a storage device 1208 comprising, for example, a magnetic tape, a hard disk, etc.; and a communication device 1209. The communication device 1209 may allow the electronic device 1200 to communicate wirelessly or wired with other devices to exchange data. While FIG. 12 shows an electronic device 1200 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure comprise a computer program product comprising a computer program embodied on a computer readable medium, the computer program comprising program code for performing the method shown in the flowchart. In such embodiments, the computer program may be downloaded and installed from the network through the communication device 1209, or installed from the storage device 1208, or from the ROM 1202. When the computer program is executed by the processing apparatus 1201, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may comprise, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may comprise a data signal propagated in baseband or as part of a carrier, where the computer readable program code is carried. Such propagated data signals may take a variety of forms comprising, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, comprising, but not limited to: wires, optical cables, RF (radio frequency), and the like, or any suitable combination of the foregoing.

An embodiment of the present disclosure further provides a computer-readable storage medium, where the computer-readable storage medium stores a computer-executable instruction, and when the processor executes the computer-executable instruction, the method for rendering a live streaming effect according to any of the foregoing embodiments is implemented.

An embodiment of the present disclosure further provides a computer program product, comprising a computer program, where the computer program, when executed by a processor, implements the method for rendering a live streaming effect according to any of the foregoing embodiments.

The computer-readable medium described above may be comprised in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, comprising object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, comprising a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “a unit for obtaining at least two Internet Protocol addresses”.

The functions described above may be performed, at least in part, by one or more hardware logic components. For example, without limitation, example types of hardware logic components that may be used comprise: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may comprise, but is not limited to, electronic, magnetic, optical, electromagnetic, infrared, or semiconductor systems, devices, or devices, or any suitable combination of the foregoing. More specific examples of machine-readable storage media may comprise electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

In a first aspect, a method for rendering a live streaming effect is provided according to one or more embodiments of the disclosure, comprising:
obtaining a live streaming image frame corresponding to a virtual reality live streaming content and a predetermined target effect;
determining key point information corresponding to at least part of a target object in the live streaming image frame;
performing an effect rendering operation on the live streaming image frame according to the target effect and the key point information to obtain a target image frame;
displaying the target image frame.

According to one or more embodiments of the disclosure, performing the effect rendering operation on the live streaming image frame according to the target effect and the key point information to obtain the target image frame comprises:
determining a target region in which at least part of the target object is located in the live streaming image frame according to the key point information corresponding to the at least part of the target object;
in accordance with a determination that the target effect is a locally applied effect, for at least part of the target region, performing a local rendering operation on the target region according to the target effect to obtain a rendering result of the target region;
for at least part of the target region, covering the live streaming image frame with the rendering result of target region to obtain the target image frame.

According to one or more embodiments of the disclosure, performing the local rendering operation on the target region according to the target effect comprises:
in response to detecting that the target effect meets a predetermined external expansion condition, performing an external expansion operation on the target region according to a predetermined region external expansion algorithm to obtain a region to be rendered; performing a local rendering operation on the region to be rendered according to the target effect.

According to one or more embodiments of the disclosure, performing the effect rendering operation on the live streaming image frame according to the target effect and the key point information to obtain the target image frame comprises:
in accordance with a determination that the target effect is a globally applied effect, performing an effect rendering operation on the live streaming image frame according to the target effect to obtain the target image frame.

According to one or more embodiments of the disclosure, determining key point information corresponding to at least part of the target object in the live streaming image frame comprises:
determining, by a predetermined central processing unit, key point information corresponding to at least part of the target object in the live streaming image frame;
performing the effect rendering operation on the live streaming image frame according to the target effect and the key point information to obtain the target image frame comprises:
performing, by a predetermined graphics processor, an effect rendering operation on the live streaming image frame according to the target effect and the key point information, to obtain the target image frame.

According to one or more embodiments of the disclosure, determining key point information corresponding to at least part of the target object in the live streaming image frame comprises:
performing a size adjustment operation on the live streaming image frame to obtain an adjusted live streaming image frame;
determining, by a central processing unit, key point information corresponding to at least part of the target object in the adjusted live streaming image frame.

According to one or more embodiments of the disclosure, determining key point information corresponding to at least part of the target object in the live streaming image frame comprises:
performing, by a graphics processor, a first scaling operation on the live streaming image frame to obtain a live streaming image frame with a first predetermined resolution, and sending the live streaming image frame with the first predetermined resolution to a central processing unit;
detecting, by the central processing unit, a prediction region corresponding to at least part of the target object in the live streaming image frame with the first predetermined resolution according to a predetermined first detection algorithm, and sending the prediction region corresponding to the at least part of the target object to the graphics processor;
performing a clipping operation, by the graphics processor, on at least part of the target object in the live streaming image frame according to the prediction region to obtain an original pixel image corresponding to at least part of the prediction region, and sending the original pixel image corresponding to the at least part of the prediction region to the central processing unit;
determining, by the central processing unit, key points corresponding to the target object in the at least part of prediction region according to a predetermined second detection algorithm.

According to one or more embodiments of the disclosure, sending the original pixel image corresponding to the at least part of prediction region to the central processing unit comprises:
performing, by the graphics processor, a second scaling operation on the original pixel image corresponding to the at least part of prediction region, to obtain an original pixel image with a second predetermined resolution corresponding to the at least part of prediction region;
sending the original pixel image with the second predetermined resolution corresponding to the at least part of prediction region to the central processing unit.

According to one or more embodiments of the disclosure, the key point information comprises coordinate information of a plurality of key points corresponding to a target object; and performing the effect rendering operation on the live streaming image frame according to the target effect and the key point information to obtain the target image frame comprises:
determining, by a graphics processor, a target region in which at least part of the target object is located in the live streaming image frame according to the key point information corresponding to the at least part of the target object;
for the target region, performing an effect rendering operation on the target region or the live streaming image frame by using a rendering mode matching the target effect, to obtain the target image frame.

According to one or more embodiments of the disclosure, before obtaining the live streaming image frame corresponding to the virtual reality live streaming content and the predetermined target effect, the following are further comprised:
obtaining, by a graphics processor, an original image frame corresponding to a virtual reality live streaming content collected by a binocular image collecting apparatus, and performing a hardware decoding operation and a format conversion operation on the original image frame to obtain the live streaming image frame.

According to one or more embodiments of the disclosure, detecting, by the central processing unit, the prediction region corresponding to at least part of the target object in the live streaming image frame with the first predetermined resolution according to the predetermined first detection algorithm comprises:
performing a detection operation on a target object in the live streaming image frame with the first predetermined resolution according to the predetermined first detection algorithm, to determine a first region where at least part of the target object is located;
determining, for at least two first regions meeting a predetermined merging condition, whether a size of a merged region after merging the at least two first regions is greater than a size before merging the at least two first regions;
if yes, determining the first region as the prediction region;
if not, determining the merged region as the prediction region.

According to one or more embodiments of the disclosure, before obtaining the live streaming image frame corresponding to the virtual reality live streaming content and the predetermined target effect, the following are further comprised:
in response to a test instruction triggered by a user, obtaining a test image frame corresponding to the virtual reality live streaming content;
performing a test operation, according to a test type corresponding to the test instruction, on the test image frame by using a test mode corresponding to the test type,
obtaining the live streaming image frame corresponding to the virtual reality live streaming content and the predetermined target effect comprises:
upon the test image frame meets a predetermined live streaming condition, obtaining the live streaming image frame corresponding to the virtual reality live streaming content and the predetermined target effect.

According to one or more embodiments of the disclosure, the test type comprises a first test type, and performing a testing operation, according to the test type corresponding to the test instruction, on the test image frame by using the test mode corresponding to the test type comprises:
performing a brightness detection on the test image frame by a brightness detection algorithm corresponding to the first test type to obtain a brightness detection result.

According to one or more embodiments of the disclosure, after performing the brightness detection on the test image frame through the brightness detection algorithm corresponding to the first test type to obtain the brightness detection result, the following are further comprised:
in response to detecting that the brightness detection result meets a predetermined live streaming condition, obtaining a live streaming image frame corresponding to the virtual reality live streaming content and a predetermined target effect;
in response to detecting that the brightness detection result does not meet the predetermined live streaming condition, displaying a predetermined first prompt for prompting the user to adjust the brightness of the current position to a predetermined brightness threshold.

According to one or more embodiments of the disclosure, the test type comprises a second test type, and performing a testing operation, according to the test type corresponding to the test instruction, on the test image frame by using the test mode corresponding to the test type comprises:
detecting the test image frame by a focusing test algorithm corresponding to the second test type to obtain a focusing detection result.

According to one or more embodiments of the disclosure, after detecting the test image frame by the focusing test algorithm corresponding to the second test type to obtain the focusing detection result, the following are further comprised:
in response to detecting that the focusing detection result meets a predetermined live streaming condition, obtaining a live streaming image frame corresponding to the virtual reality live streaming content and a predetermined target effect;
in response to detecting that the focusing detection result does not meet the predetermined live streaming condition, displaying a predetermined second prompt for prompting the user to reperform a focusing operation.

In a second aspect, an apparatus for rendering a live streaming effect is provided according to one or more embodiments of the disclosure, comprising:
an obtaining module configured to obtain a live streaming image frame corresponding to a virtual reality live streaming content and a predetermined target effect;
a determination module configured to determine key point information corresponding to at least part of a target object in the live streaming image frame;
a rendering module configured to perform an effect rendering operation on the live streaming image frame according to the target effect and the key point information to obtain a target image frame;
a display module configured to display the target image frame.

According to one or more embodiments of the disclosure, the rendering module is configured to: determine a target region in which at least part of the target object is located in the live streaming image frame according to the key point information corresponding to the at least part of the target object;
in accordance with a determination that the target effect is a locally applied effect, for at least part of the target region, perform a local rendering operation on the target region according to the target effect to obtain a rendering result of the target region;
for at least part of the target region, cover the live streaming image frame with the rendering result of target region to obtain the target image frame.

According to one or more embodiments of the disclosure, the rendering module is configured to:
in response to detecting that the target effect meets a predetermined external expansion condition, perform an external expansion operation on the target region according to a predetermined region external expansion algorithm to obtain a region to be rendered;
perform a local rendering operation on the region to be rendered according to the target effect.

According to one or more embodiments of the disclosure, the rendering module is configured to:
in accordance with a determination that the target effect is a globally applied effect, perform an effect rendering operation on the live streaming image frame according to the target effect to obtain the target image frame.

According to one or more embodiments of the disclosure, the determination module is configured to:
determine, by a predetermined central processing unit, key point information corresponding to at least part of the target object in the live streaming image frame;
the rendering module is configured to:
perform, by a predetermined graphics processor, an effect rendering operation on the live streaming image frame according to the target effect and the key point information, to obtain the target image frame.

According to one or more embodiments of the disclosure, the determination module is configured to:
perform a size adjustment operation on the live streaming image frame to obtain an adjusted live streaming image frame;
determine, by a central processing unit, key point information corresponding to at least part of the target object in the adjusted live streaming image frame.

According to one or more embodiments of the disclosure, the determination module is configured to:
perform, by a graphics processor, a first scaling operation on the live streaming image frame to obtain a live streaming image frame with a first predetermined resolution, and send the live streaming image frame with the first predetermined resolution to a central processing unit;
detect, by the central processing unit, a prediction region corresponding to at least part of the target object in the live streaming image frame with the first predetermined resolution according to a predetermined first detection algorithm, and send the prediction region corresponding to the at least part of the target object to the graphics processor;
perform a clipping operation, by the graphics processor, on at least part of the target object in the live streaming image frame according to the prediction region to obtain an original pixel image corresponding to at least part of the prediction region, and send the original pixel image corresponding to the at least part of the prediction region to the central processing unit;
determine, by the central processing unit, key points corresponding to the target object in the at least part of prediction region according to a predetermined second detection algorithm.

According to one or more embodiments of the disclosure, the determination module is configured to:
perform, by the graphics processor, a second scaling operation on the original pixel image corresponding to the at least part of prediction region, to obtain an original pixel image with a second predetermined resolution corresponding to the at least part of prediction region;
send the original pixel image with the second predetermined resolution corresponding to the at least part of prediction region to the central processing unit.

According to one or more embodiments of the disclosure, the key point information comprises coordinate information of a plurality of key points corresponding to a target object; and the rendering module is configured to:
determine, by a graphics processor, a target region in which at least part of the target object is located in the live streaming image frame according to the key point information corresponding to the at least part of the target object;
for the target region, perform an effect rendering operation on the target region or the live streaming image frame by using a rendering mode matching the target effect, to obtain the target image frame.

According to one or more embodiments of the disclosure, the apparatus further comprises: a preprocessing module configured to:
obtain, by a graphics processor, an original image frame corresponding to a virtual reality live streaming content collected by a binocular image collecting apparatus, and perform a hardware decoding operation and a format conversion operation on the original image frame to obtain the live streaming image frame.

According to one or more embodiments of the disclosure, the rendering module is configured to:
perform a detection operation on a target object in the live streaming image frame with the first predetermined resolution according to the predetermined first detection algorithm, to determine a first region where at least part of the target object is located;
determine, for at least two first regions meeting a predetermined merging condition, whether a size of a merged region after merging the at least two first regions is greater than a size before merging the at least two first regions;
if yes, determine the first region as the prediction region;
if not, determine the merged region as the prediction region.

According to one or more embodiments of the disclosure, the apparatus further comprises a obtaining module configured to: in response to a test instruction triggered by a user, obtain a test image frame corresponding to the virtual reality live streaming content; a test module configured to: perform a test operation, according to a test type corresponding to the test instruction, on the test image frame by using a test mode corresponding to the test type; the obtaining module further configured to: upon the test image frame meets a predetermined live streaming condition, obtain the live streaming image frame corresponding to the virtual reality live streaming content and the predetermined target effect.

According to one or more embodiments of the disclosure, the test type comprises a first test type, and the test module is configured to: perform a brightness detection on the test image frame by a brightness detection algorithm corresponding to the first test type to obtain a brightness detection result.

According to one or more embodiments of the disclosure, the apparatus further comprises the processing module configured to, in response to detecting that the brightness detection result meets a predetermined live streaming condition, obtain a live streaming image frame corresponding to the virtual reality live streaming content and a predetermined target effect; the processing module further configured to: in response to detecting that the brightness detection result does not meet the predetermined live streaming condition, display a predetermined first prompt for prompting the user to adjust the brightness of the current position to a predetermined brightness threshold.

According to one or more embodiments of the disclosure, the test type comprises a second test type, and the test module is configured to: detect the test image frame by a focusing test algorithm corresponding to the second test type to obtain a focusing detection result.

According to one or more embodiments of the disclosure, the apparatus further comprises: the processing module configured to, in response to detecting that the focusing detection result meets a predetermined live streaming condition, obtain a live streaming image frame corresponding to the virtual reality live streaming content and a predetermined target effect; the processing module configured to, in response to detecting that the focusing detection result does not meet the predetermined live streaming condition, display a predetermined second prompt for prompting the user to reperform a focusing operation.

In a third aspect, an electronic device is provided according to one or more embodiments of this disclosure, comprising: a processor and a memory;
the memory storing computer executable instructions;
the processor executing the computer executable instructions stored in the memory, to enable the processor to execute a method for rendering a live streaming effect according to the above first aspect and various possible designs thereof.

In a fourth aspect, a computer-readable storage medium is provided according to one or more embodiments of this disclosure. The computer-readable storage medium stores computer-executable instructions which, when executed by a processor, implement a method for rendering a live streaming effect according to the above first aspect and various possible designs thereof.

In a fifth aspect, a computer program product is provided according to one or more embodiments of this disclosure, comprising a computer program. The computer program, when executed by a processor, implements a method for rendering a live streaming effect according to the above first aspect and various possible designs thereof.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in a plurality of embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely example forms of realizing the claims.

1. A method for rendering a live streaming effect, comprising:
obtaining a live streaming image frame corresponding to a virtual reality live streaming content and a predetermined effect;
determining key point information corresponding to at least part of an object in the live streaming image frame;
performing an effect rendering on the live streaming image frame according to the effect and the key point information to obtain an image frame; and
displaying the image frame.

2. The method of claim 1, performing the effect rendering on the live streaming image frame according to the effect and the key point information to obtain the image frame comprises:
determining a region in which at least part of the object is located in the live streaming image frame according to the key point information corresponding to the at least part of the object;
in accordance with a determination that the effect is a locally applied effect, for at least part of the region, performing a local rendering on the region according to the effect to obtain a rendering result of the region;
for at least part of the region, covering the live streaming image frame with the rendering result of region to obtain the image frame.

3. The method of claim 2, performing the local rendering on the region according to the effect comprises:
in response to detecting that the effect meets a predetermined external expansion condition, performing an external expansion on the region according to a predetermined region external expansion algorithm to obtain a region to be rendered; and
performing a local rendering on the region to be rendered according to the effect.

4. The method of claim 1, performing the effect rendering operation on the live streaming image frame according to the effect and the key point information to obtain the image frame comprises:
in accordance with a determination that the effect is a globally applied effect, performing an effect rendering on the live streaming image frame according to the effect to obtain the image frame.

5. The method of claim 1, determining key point information corresponding to at least part of the object in the live streaming image frame comprises:
determining, by a predetermined central processing unit, key point information corresponding to at least part of the object in the live streaming image frame;
performing the effect rendering on the live streaming image frame according to the effect and the key point information to obtain the image frame comprises:
performing, by a predetermined graphics processor, an effect rendering on the live streaming image frame according to the effect and the key point information, to obtain the image frame.

6. The method of claim 1, determining key point information corresponding to at least part of the object in the live streaming image frame comprises:
performing a size adjustment on the live streaming image frame to obtain an adjusted live streaming image frame; and
determining, by a central processing unit, key point information corresponding to at least part of the object in the adjusted live streaming image frame.

7. The method of claim 1, determining key point information corresponding to at least part of the object in the live streaming image frame comprises:
performing, by a graphics processor, a first scaling operation on the live streaming image frame to obtain a live streaming image frame with a first predetermined resolution, and sending the live streaming image frame with the first predetermined resolution to a central processing unit;
detecting, by the central processing unit, a prediction region corresponding to at least part of the object in the live streaming image frame with the first predetermined resolution according to a predetermined first detection algorithm, and sending the prediction region corresponding to the at least part of the object to the graphics processor;
clipping, by the graphics processor, at least part of the object in the live streaming image frame according to the prediction region to obtain an original pixel image corresponding to at least part of the prediction region, and sending the original pixel image corresponding to the at least part of the prediction region to the central processing unit; and
determining, by the central processing unit, key points corresponding to the object in the at least part of prediction region according to a predetermined second detection algorithm.

8. The method of claim 7, sending the original pixel image corresponding to the at least part of prediction region to the central processing unit comprises:
performing, by the graphics processor, a second scaling operation on the original pixel image corresponding to the at least part of prediction region, to obtain an original pixel image with a second predetermined resolution corresponding to the at least part of prediction region; and
sending the original pixel image with the second predetermined resolution corresponding to the at least part of prediction region to the central processing unit.

9. The method of claim 1, the key point information comprises coordinate information of a plurality of key points corresponding to an object; and performing the effect rendering on the live streaming image frame according to the effect and the key point information to obtain the image frame comprises:
determining, by a graphics processor, a region in which at least part of the object is located in the live streaming image frame according to the key point information corresponding to the at least part of the object;
for the region, performing an effect rendering on the region or the live streaming image frame by using a rendering mode matching the effect, to obtain the image frame.

10. The method of claim 1, before obtaining the live streaming image frame corresponding to the virtual reality live streaming content and the predetermined effect, the method further comprises:
obtaining, by a graphics processor, an original image frame corresponding to a virtual reality live streaming content collected by a binocular image collecting apparatus, and performing a hardware decoding and a format conversion on the original image frame to obtain the live streaming image frame.

11. The method of claim 7, detecting, by the central processing unit, the prediction region corresponding to at least part of the object in the live streaming image frame with the first predetermined resolution according to the predetermined first detection algorithm comprises:
detecting an object in the live streaming image frame with the first predetermined resolution according to the predetermined first detection algorithm, to determine a first region where at least part of the object is located;
determining, for at least two first regions meeting a predetermined merging condition, whether a size of a merged region after merging the at least two first regions is greater than a size before merging the at least two first regions;
in respond to the size of the merged region after merging the at least two first regions being greater than the size before merging the at least two first regions, determining the first region as the prediction region;
in respond to the size of the merged region after merging the at least two first regions not being larger than the size before merging the at least two first regions, determining the merged region as the prediction region.

12. The method of claim 1, before obtaining the live streaming image frame corresponding to the virtual reality live streaming content and the predetermined effect, the method further comprises:
in response to a test instruction triggered by a user, obtaining a test image frame corresponding to the virtual reality live streaming content;
according to a test type corresponding to the test instruction, testing the test image frame by using a test mode corresponding to the test type,
obtaining the live streaming image frame corresponding to the virtual reality live streaming content and the predetermined effect comprises:
upon the test image frame meets a predetermined live streaming condition, obtaining the live streaming image frame corresponding to the virtual reality live streaming content and the predetermined effect.

13. The method of claim 12, the test type comprises a first test type, and according to the test type corresponding to the test instruction, testing the test image frame by using the test mode corresponding to the test type comprises:
performing a brightness detection on the test image frame by a brightness detection algorithm corresponding to the first test type to obtain a brightness detection result.

14. The method of claim 13, after performing the brightness detection on the test image frame through the brightness detection algorithm corresponding to the first test type to obtain the brightness detection result, the method further comprises:
in response to detecting that the brightness detection result meets a predetermined live streaming condition, obtaining a live streaming image frame corresponding to the virtual reality live streaming content and a predetermined effect;
in response to detecting that the brightness detection result does not meet the predetermined live streaming condition, displaying a predetermined first prompt for prompting the user to adjust the brightness of the current position to a predetermined brightness threshold.

15. The method of claim 12, the test type comprises a second test type, and according to the test type corresponding to the test instruction, testing the test image frame by using the test mode corresponding to the test type comprises:
detecting the test image frame by a focusing test algorithm corresponding to the second test type to obtain a focusing detection result.

16. The method of claim 15, after detecting the test image frame by the focusing test algorithm corresponding to the second test type to obtain the focusing detection result, the method further comprises:
in response to detecting that the focusing detection result meets a predetermined live streaming condition, obtaining a live streaming image frame corresponding to the virtual reality live streaming content and a predetermined effect;
in response to detecting that the focusing detection result does not meet the predetermined live streaming condition, displaying a predetermined second prompt for prompting the user to reperform a focusing operation.

17. (canceled)

18. An electronic device, comprising: a processor and a memory;
the memory storing computer executable instructions;
the processor executing the computer executable instructions stored in the memory, to enable the processor to execute acts comprising:
obtaining a live streaming image frame corresponding to a virtual reality live streaming content and a predetermined effect;
determining key point information corresponding to at least part of an object in the live streaming image frame;
performing an effect rendering on the live streaming image frame according to the effect and the key point information to obtain an image frame; and
displaying the image frame.

19-20. (canceled)

21. The electronic device of claim 18, performing the effect rendering on the live streaming image frame according to the effect and the key point information to obtain the image frame comprises:
determining a region in which at least part of the object is located in the live streaming image frame according to the key point information corresponding to the at least part of the object;
in accordance with a determination that the effect is a locally applied effect, for at least part of the region, performing a local rendering on the region according to the effect to obtain a rendering result of the region;
for at least part of the region, covering the live streaming image frame with the rendering result of region to obtain the image frame.

22. The electronic device of claim 21, performing the local rendering on the region according to the effect comprises:
in response to detecting that the effect meets a predetermined external expansion condition, performing an external expansion on the region according to a predetermined region external expansion algorithm to obtain a region to be rendered; and
performing a local rendering on the region to be rendered according to the effect.

23. A non-transitory computer-readable storage medium, characterized in that the computer-readable storage medium stores computer-executable instructions which, when executed by a processor, implement a method comprising:
obtaining a live streaming image frame corresponding to a virtual reality live streaming content and a predetermined effect;
determining key point information corresponding to at least part of an object in the live streaming image frame;
performing an effect rendering on the live streaming image frame according to the effect and the key point information to obtain an image frame; and
displaying the image frame.
